(19) United States
(12) Patent Application Publication
(10) Pub. No.: US 2026/0066782 A1
(43) Pub. Date: Mar. 5, 2026

(54) CHARGE PUMP CIRCUIT AND CONTROL METHOD FOR CHARGE PUMP CIRCUIT

(71) Applicant: SUZHOU NOVOSENSE MICROELECTRONICS CO., LTD., Suzhou (CN)

(72) Inventors: Di LUO, Suzhou (CN); Tao LIN, Suzhou (CN)

(21) Appl. No.: 19/301,967

(22) Filed: Aug. 16, 2025

(30) Foreign Application Priority Data
Sep. 3, 2024 (CN) 202411230449.7

(51) Int. Cl. H02M 3/07

(52) U.S. Cl. CPC H02M 3/07

(57) ABSTRACT

A charge pump circuit and control method for the charge pump circuit. The charge pump circuit has an input port to receive a supply voltage, and an output port to provide an output voltage. The charge pump circuit has a first switching transistor, a first capacitor, and a regulating circuit. The first switching transistor has a first terminal and a second terminal, when the first switching transistor is turned on, a current of the first switching transistor flows from the first terminal to the second terminal. The first capacitor has a first terminal and a second terminal, the first terminal of the first capacitor is coupled to the first terminal or the second terminal of the first switching transistor. The regulating circuit is configured to receive the output voltage and a first switch control signal, and generate a regulating signal to control on and off of the first switching transistor.

### CROSS-REFERENCE TO RELATED APPLICATIONS

The present application claims priority to and the benefit of Chinese Patent Application No. 202411230449.7, filed on September 03, 2024, the disclosures of which is incorporated herein by reference in its entirety.

### TECHNICAL FIELD

The present application relates to the technical field of charge pump circuits, and in particular, to a charge pump circuit and a control method for the charge pump circuit.

### BACKGROUND

As a common circuit module, the charge pump can provide functions such as boosting voltage, reducing voltage, or generating negative voltage. A basic charge pump topology typically includes a conduction loop having at least a plurality of capacitors and a plurality of switches, and controlled by a plurality of alternating cycles. Capacitors are used as energy storage elements, and charge transfer is controlled through periodic switching operations. Specifically, during each switching cycle, the capacitor is charged by the supply voltage to have charges corresponding to a certain voltage across two plates. Then, by controlling the switches in the circuit, another conduction loop is formed, the charges on the capacitor are transferred to alter the charge distribution in the loop, and the desired output voltage is obtained from a preset output port.

In some simple charge pump circuits (such as negative voltage charge pumps or voltage doubler charge pumps), the output voltages of the circuits heavily rely on the supply voltage. If the supply voltage fluctuates with a relatively large variation range, the output voltage will fluctuate in tandem with the supply voltage, leading to occurrence of output instability. Therefore, a charge pump circuit capable of generating a stable output voltage is needed.

### SUMMARY

The technical objective of the present application is to provide a charge pump circuit and a control method for the charge pump circuit, so as to improve the problem of unstable output voltage of the charge pump.

To achieve the above technical objective, the present application adopts the following technical solutions.

According to a first aspect of the present application, embodiments of the present application provide a charge pump circuit, including: an input port, configured to receive a supply voltage; an output port, configured to provide an output voltage; a first switching transistor, having a first terminal, a second terminal, and a control terminal, where when the first switching transistor is turned on, a current of the first switching transistor flows from the first terminal of the first switching transistor to the second terminal of the first switching transistor; a first capacitor, having a first terminal and a second terminal, where the first terminal of the first capacitor is coupled to the first terminal of the first switching transistor or the second terminal of the first switching transistor; and a regulating circuit, configured to receive the output voltage and a first switch control signal, and generate a regulating signal to control on and off of the first switching transistor according to the output voltage and the first switch control signal; where the regulating signal is configured to control an on-resistance of the first switching transistor to regulate the output voltage.

In a second aspect, embodiments of the present application provide a control method for a charge pump circuit, where the charge pump circuit includes a first switching transistor and a first capacitor, where the first switching transistor includes a first terminal and a second terminal, and the first capacitor includes a first terminal and a second terminal, where the first capacitor is connected to the first terminal or the second terminal of the first switching transistor, and the charge pump circuit is configured to convert an input voltage received by an input port into an output voltage by controlling on and off of the first switching transistor, where the control method includes: generating a feedback voltage indicative of the output voltage according to the output voltage; and generating a regulating signal according to the feedback voltage and a reference voltage to control an on-resistance of the first switching transistor.

Through one or more of the above embodiments of the present application, at least the following technical effects can be achieved: the regulating circuit in the charge pump circuit can generate a regulating signal according to an output voltage of the charge pump circuit and a first switch control signal, and output the regulating signal to a control terminal of the first switching transistor, so as to change an on-resistance of the first switching transistor and further feedback-regulate the output voltage, thereby improving the problem of unstable output voltage of the charge pump.

### BRIEF DESCRIPTION OF THE DRAWINGS

To more clearly illustrate the technical solutions in the embodiments of the present application, the accompanying drawings needed in the description of the embodiments will be briefly introduced below. Obviously, the accompanying drawings in the following description are merely some embodiments of the present application. For those skilled in the art, other accompanying drawings can also be obtained according to these accompanying drawings without making creative efforts.

FIG. 1 is a schematic diagram of a circuit structure of a charge pump circuit according to an embodiment of the present application;

FIG. 2 is a schematic diagram of a circuit structure of a charge pump circuit according to an embodiment of the present application;

FIG. 3 is a schematic diagram of a circuit structure of a charge pump circuit according to an embodiment of the present application;

FIG. 4 is a schematic diagram of a circuit structure of a charge pump circuit according to an embodiment of the present application;

FIG. 5 is a schematic diagram of a circuit structure of a charge pump circuit according to an embodiment of the present application;

FIG. 6 is a schematic diagram of a circuit structure of a charge pump circuit according to an embodiment of the present application;

FIG. 7 is a waveform diagram of each signal in the charge pump circuit shown in FIG. 6;

FIG. 8 is a schematic diagram of a circuit structure of a charge pump circuit according to an embodiment of the present application;

FIG. 9 is a schematic diagram of a circuit structure of a charge pump circuit according to an embodiment of the present application;

FIG. 10 is a schematic diagram of a circuit structure of a charge pump circuit according to an embodiment of the present application.

### DETAILED DESCRIPTION

The following will clearly and completely describe the technical solutions in embodiments of the present application with reference to the accompanying drawings in embodiments of the present application. Obviously, the described embodiments are merely some embodiments rather than all embodiments of the present application. Based on the embodiments in the present application, all other embodiments obtained by those skilled in the art without creative labors shall fall within the protection scope of the present application.

It should be noted that, in the description of the present application, unless otherwise clearly specified and limited, the terms “connected” and “connection” should be understood in a broad sense and, for example, may be a fixed connection, a detachable connection, or an integral connection; and may be a mechanical connection, an electrical connection, or capable of communicating with each other; and may be a direct connection, or an indirect connection through an intermediate medium, or an internal communication between two components or an interaction relationship between two components. For those of ordinary skill in the art, the specific meanings of the above terms in the present application can be understood according to specific situations. In the description of the present application, the meaning of “a plurality of” is two or more, unless otherwise clearly and specifically defined. In addition, the terms “first” and “second” are only used for descriptive purposes, and shall not be understood as indicating or implying relative importance or implicitly specifying the quantity of indicated technical features. Thus, a feature defined with “first” or “second” may explicitly or implicitly include one or more features.

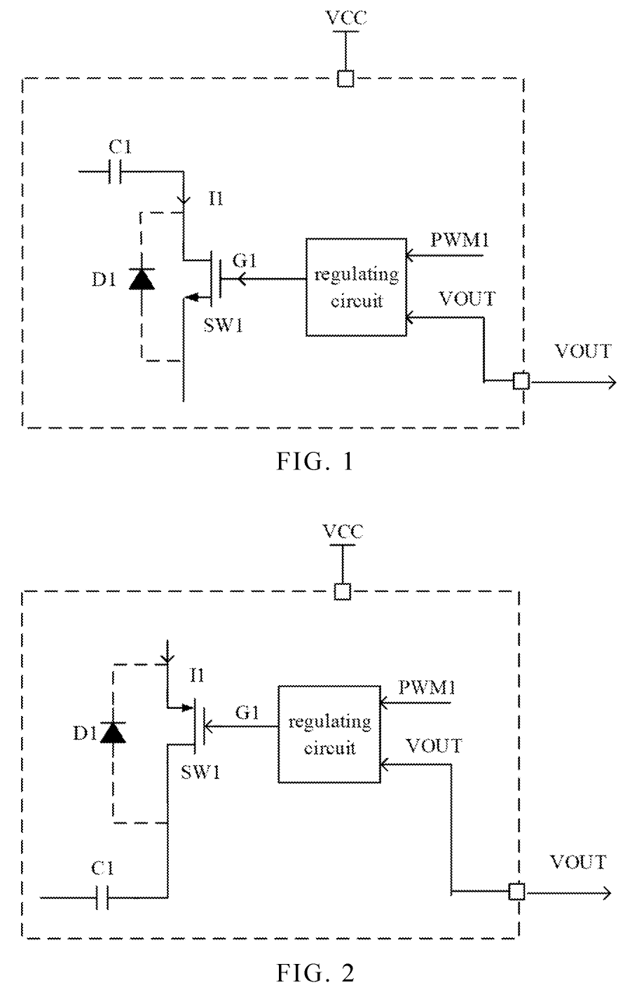

FIG. 1 is a schematic diagram of a circuit structure of a charge pump circuit according to an embodiment of the present application. The charge pump circuit includes an input port, an output port, a first switching transistor SW1, a first capacitor C1, and a regulating circuit 10. The input port receives a supply voltage VCC, and the output port provides an output voltage VOUT. The first switching transistor SW1 has a first terminal, a second terminal, and a control terminal; when the first switching transistor SW1 is turned on, a current I1 of the first switching transistor SW1 flows from the first terminal of the first switching transistor SW1 to the second terminal of the first switching transistor SW1. The first capacitor C1 has a first terminal and a second terminal, and the first terminal of the first capacitor C1 is coupled to the first terminal of the first switching transistor SW1. The regulating circuit 10 receives the output voltage VOUT and a first switch control signal PWM1, and generates a regulating signal G1 to control on and off of the first switching transistor SW1 according to the output voltage VOUT and the first switch control signal PWM1, where the regulating signal G1 regulates the output voltage VOUT by controlling an on-resistance of the first switching transistor SW1. In the embodiment shown in FIG. 1, the first switching transistor SW1 is an N-type field effect transistor. The first terminal of the first switching transistor SW1 is a drain terminal of the N-type field effect transistor. It should be noted that in other embodiments, the first terminal of the first capacitor C1 may be coupled to the second terminal of the first switching transistor SW1, that is, coupled to a source terminal of the N-type field effect transistor.

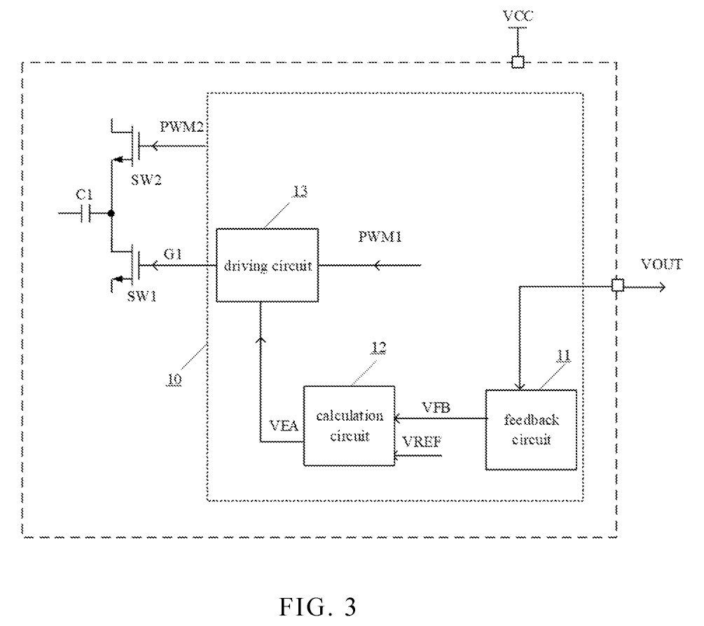

FIG. 2 is a schematic diagram of a circuit structure of a charge pump circuit according to an embodiment of the present application. The charge pump circuit includes an input port, an output port, a first switching transistor SW1, a first capacitor C1, and a regulating circuit 10. The input port receives a supply voltage VCC, and the output port provides an output voltage VOUT. The first switching transistor SW1 has a first terminal, a second terminal, and a control terminal; when the first switching transistor SW1 is turned on, a current of the first switching transistor SW1 flows from the first terminal of the first switching transistor SW1 to the second terminal of the first switching transistor SW1. The first capacitor C1 has a first terminal and a second terminal, and the first terminal of the first capacitor C1 is coupled to the second terminal of the first switching transistor SW1. The regulating circuit 10 receives the output voltage VOUT and a first switch control signal PWM1, and generates a regulating signal G1 to control on and off of the first switching transistor SW1 according to the output voltage VOUT and the first switch control signal PWM1, where the regulating signal G1 controls an on-resistance of the first switching transistor SW1 to regulate the output voltage VOUT. In the embodiment shown in FIG. 2, the first switching transistor SW1 is a P-type field effect transistor. The second terminal of the first switching transistor SW1 is a drain terminal of the P-type field effect transistor. It should be noted that in other embodiments, the first terminal of the first capacitor C1 may be coupled to the first terminal of the first switching transistor SW1, that is, coupled to a source terminal of the P-type field effect transistor.

In the embodiment shown in FIG. 1 or FIG. 2, the first switching transistor SW1 has a parasitic diode D1, the first terminal of the first switching transistor SW1 is a cathode of the parasitic diode D1, and the second terminal of the first switching transistor SW1 is an anode of the parasitic diode D1.

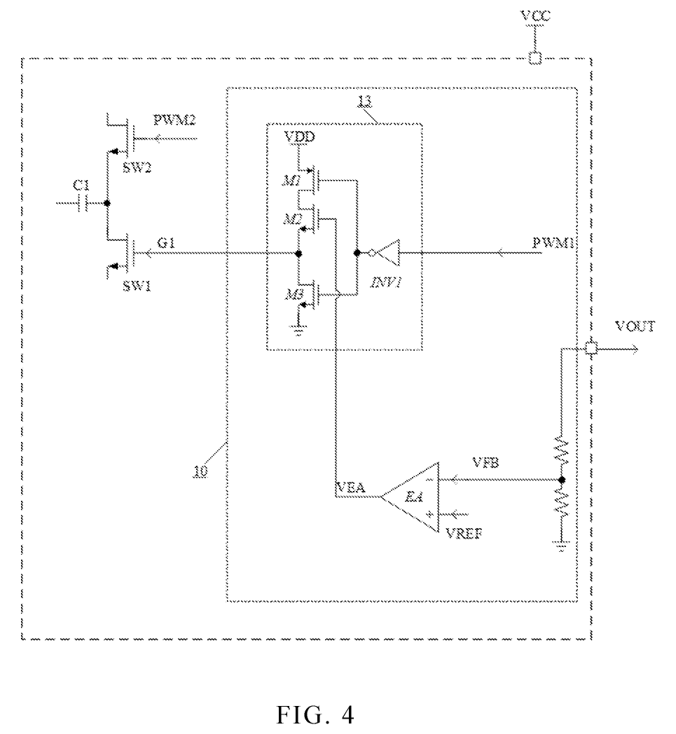

FIG. 3 is a schematic diagram of a circuit structure of a charge pump circuit according to an embodiment of the present application. As shown in FIG. 3, the charge pump circuit further includes a second switching transistor SW2, where during a first operation cycle, the first switching transistor SW1 is turned on and the second switching transistor SW2 is turned off, and during a second operation cycle, the first switching transistor SW1 is turned off and the second switching transistor SW2 is turned on. In the embodiment shown in FIG. 3, the first switching transistor SW1 is an N-type transistor, and the second switching transistor SW2 is an N-type transistor. It should be noted that the first switching transistor SW1 being an N-type transistor and the second switching transistor SW2 being an N-type transistor is only an example; in other embodiments, the first switching transistor SW1 may be a P-type transistor, the second switching transistor SW2 may also be a P-type transistor, and the first switching transistor SW1 and the second switching transistor SW2 may be transistors of different types.

In the embodiment shown in FIG. 3, the regulating circuit 10 includes a feedback circuit 11, a calculation circuit 12, and a driving circuit 13, where the feedback circuit 11 generates a feedback signal VFB indicative of the output voltage VOUT according to the output voltage VOUT, the calculation circuit 12 generates a calculation signal VEA according to the feedback signal VFB and a reference voltage signal VREF, the driving circuit 13 has a first input terminal configured to receive the first switch control signal PWM1 and a second input terminal configured to receive the calculation signal VEA, and the driving circuit 13 generates the regulating signal G1 according to the first switch control signal PWM1 and the calculation signal VEA. In an embodiment, a voltage of the feedback signal VFB is K×VOUT, where VOUT is a voltage of the output signal. In an embodiment, the first switch control signal PWM1 is a square wave signal with a duty cycle of 50%.

FIG. 4 is a schematic diagram of a circuit structure of a charge pump circuit according to an embodiment of the present application. As shown in FIG. 4, the driving circuit 13 includes a first transistor M1, a second transistor M2, and a third transistor M3 serially coupled between a power supply voltage VDD and a reference ground. The first transistor M1 has a first terminal, a second terminal, and a control terminal, where the first terminal of the first transistor M1 receives the power supply voltage VDD, and the control terminal of the first transistor M1 receives the first switch control signal PWM1. The second transistor M2 has a first terminal, a second terminal, and a control terminal, where the first terminal of the second transistor M2 is coupled to the second terminal of the first transistor M1, and the control terminal of the second transistor M2 receives the calculation signal VEA. The third transistor M3 has a first terminal, a second terminal, and a control terminal, where the first terminal of the third transistor M3 is coupled to the second terminal of the second transistor M2 and outputs the regulating signal G1, the second terminal of the third transistor M3 is coupled to the reference ground, and the control terminal of the third transistor M3 receives the first switch control signal PWM1. In the embodiment shown in FIG. 4, the driving circuit 13 further includes a first inverter INV1, and the first inverter INV1 inverts the first switch control signal PWM1 and inputs the inverted first switch control signal PWM1 to the control terminals of the first transistor M1 and the third transistor M3. In other embodiments, the first transistor has a first terminal, a second terminal, and a control terminal, where the first terminal of the first transistor receives the power supply voltage, and the control terminal of the first transistor receives the regulating signal.

In the embodiment shown in FIG. 4, the first switching transistor is an N-type field effect transistor, the second switching transistor is an N-type field effect transistor, the first transistor M1 is a P-type field effect transistor, and the second transistor M2 and the third transistor M3 are N-type field effect transistors. When the calculation signal VEA received by the control terminal (gate terminal) of the second transistor M2 changes, the regulating signal G1 provided by the second terminal (source terminal) of the second transistor M2 changes accordingly; since the second terminal (source terminal) of the second transistor M2 is coupled to the control terminal (gate terminal) of the first switching transistor SW1, the relationship between the calculation signal VEA and the regulating signal G1 can be concluded as G1=VEA-Vgs2, where Vgs2 is a gate-source voltage of the second transistor M2. When the regulating signal G1 received by the control terminal (gate terminal) of the first switching transistor SW1 changes, the on-resistance of the first switching transistor SW1 changes accordingly; when the first switch control signal PWM1 is at a logic high level, the change in the on-resistance of the first switching transistor SW1 results in the change in a voltage at a first terminal CAPP of the first capacitor C1, thereby changing a pumping voltage VFLY, that is, the output voltage VOUT is controlled by controlling the pumping voltage VFLY of the first switching transistor SW1. In the embodiment of FIG. 4, a value of the power supply voltage VDD is fixed. In an embodiment, the power supply voltage VDD is equal to 5V. In another embodiment, the value of the power supply voltage VDD is not fixed, and the value of the power supply voltage VDD changes with the change of the calculation signal VEA. It should be noted that although a specific driving circuit is shown in FIG. 4, any driver capable of outputting the regulating signal G1 falls within the protection scope of the present application.

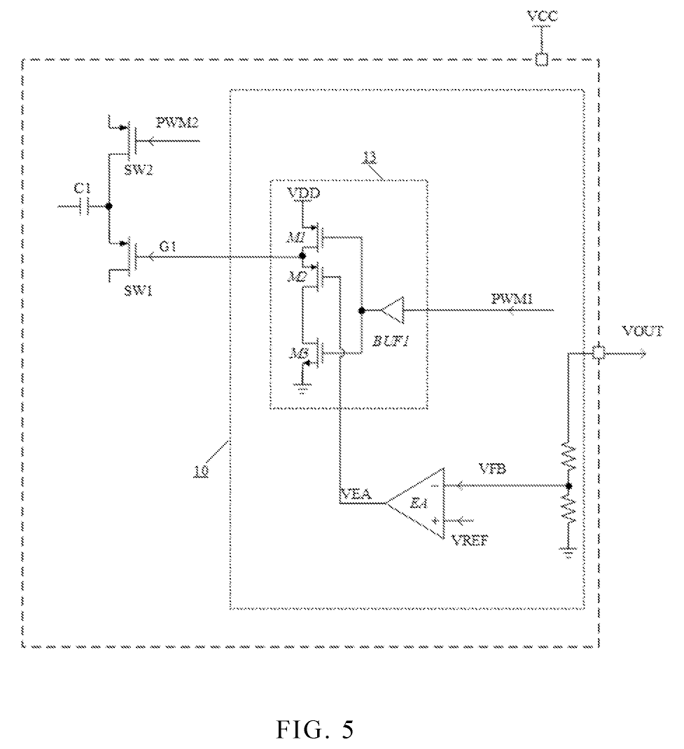

FIG. 5 is a schematic diagram of a circuit structure of a charge pump circuit according to an embodiment of the present application. Different from the embodiment shown in FIG. 4, in the embodiment shown in FIG. 5, the first switching transistor SW1 is a P-type transistor, the second switching transistor SW2 is a P-type transistor, and the structure of the corresponding driving circuit 13 is different; where the first transistor M1 in the driving circuit 13 has a first terminal, a second terminal, and a control terminal, where the first terminal of the first transistor M1 receives the power supply voltage VDD, and the control terminal of the first transistor M1 receives the first switch control signal PWM1. The second transistor M2 has a first terminal, a second terminal, and a control terminal, where the first terminal of the second transistor M2 is coupled to the second terminal of the first transistor M1 and outputs the regulating signal G1, and the control terminal of the second transistor M2 receives the calculation signal VEA. The third transistor M3 has a first terminal, a second terminal, and a control terminal, where the first terminal of the third transistor M3 is coupled to the second terminal of the second transistor M2, the second terminal of the third transistor M3 is coupled to the reference ground, and the control terminal of the third transistor M3 receives the first switch control signal PWM1. In the embodiment shown in FIG. 5, the driving circuit 13 further includes a first buffer BUF1, and the first buffer BUF1 buffers the first switch control signal PWM1 and then inputs the buffered first switch control signal PWM1 to the control terminals of the first transistor M1 and the third transistor M3. It should be noted that although a specific driving circuit is shown in FIG. 5, any driver capable of outputting the regulating signal G1 falls within the protection scope of the present application.

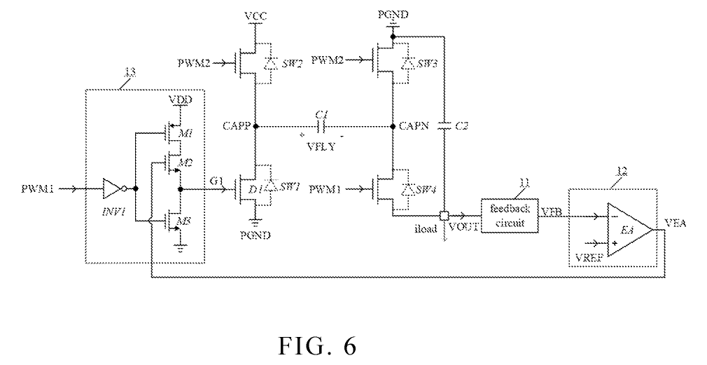

FIG. 6 is a schematic diagram of a circuit structure of a charge pump circuit according to an embodiment of the present application. A first terminal of the first capacitor C1 is coupled to the first terminal of the first switching transistor SW1, and the charge pump circuit further includes a second switching transistor SW2, a third switching transistor SW3, and a fourth switching transistor SW4, where the second switching transistor SW2 has a first terminal and a second terminal, the first terminal of the second switching transistor SW2 is coupled to the input port to receive the supply voltage VCC, and the second terminal of the second switching transistor SW2 is coupled to the first terminal of the first switching transistor SW1. The third switching transistor SW3 has a first terminal and a second terminal, the first terminal of the third switching transistor SW3 is coupled to the reference ground, and the second terminal of the third switching transistor SW3 is coupled to the second terminal of the first capacitor C1. The fourth switching transistor SW4 has a first terminal and a second terminal, the first terminal of the fourth switching transistor SW4 is coupled to the second terminal of the first capacitor C1, and the second terminal of the fourth switching transistor SW4 is coupled to the output port to provide the output voltage VOUT. During the first operation cycle, the first switching transistor SW1 and the fourth switching transistor SW4 are turned off, and the second switching transistor SW2 and the third switching transistor SW3 are turned on; and during the second operation cycle, the first switching transistor SW1 and the fourth switching transistor SW4 are turned on, and the second switching transistor SW2 and the third switching transistor SW3 are turned off.

In the embodiment shown in FIG. 6, the first switching transistor SW1 and the fourth switching transistor SW4 are turned on or turned off under the control of the first switch control signal PWM1, and the second switching transistor SW2 and the third switching transistor SW3 are turned on or turned off under the control of a second switch control signal PWM2, where the first switch control signal PWM1 is a pulse width modulation signal, and the second switch control signal PWM2 is a pulse width modulation signal; in some embodiments, the first switch control signal PWM1 is a complementary signal for the second switch control signal PWM2, and both the two are square wave signals with a duty cycle of 50%. When the first switch control signal PWM1 is at a logic high level, the second switch control signal PWM2 is at a logic low level; and when the first switch control signal PWM1 is at a logic low level, the second switch control signal PWM2 is at a logic high level. In the embodiment shown in FIG. 6, a second capacitor C2 is further included, where a first terminal of the second capacitor C2 is coupled to the reference ground, and a second terminal of the second capacitor C2 is coupled to the output port. During the first operation cycle, the first switching transistor SW1 and the fourth switching transistor SW4 are turned off, and the second switching transistor SW2 and the third switching transistor SW3 are turned on, and the supply voltage VCC charges the first capacitor C1; and during the second operation cycle, the first switching transistor SW1 and the fourth switching transistor SW4 are turned on, the second switching transistor SW2 and the third switching transistor SW3 are turned off, the first capacitor C1 charges the second capacitor C2, and a positive voltage is converted into a negative voltage at the output port for output.

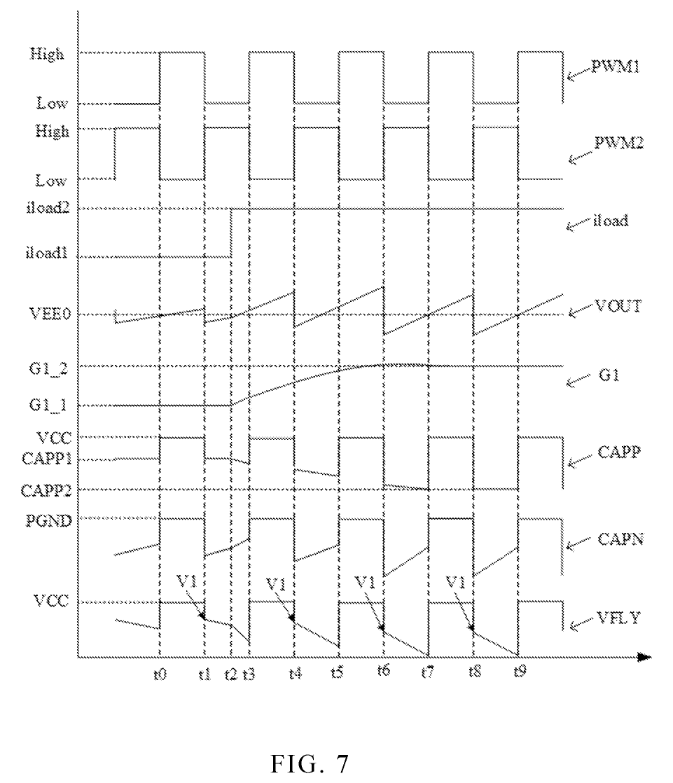

FIG. 7 is a waveform diagram of each signal in the charge pump circuit shown in FIG. 6. The waveforms of each signal in FIG. 7 will be described with reference to the charge pump circuit structure shown in FIG. 6. It should be noted that, according to the logic level states of the first switch control signal PWM1 and the second switch control signal PWM2, the charge pump circuit cyclically switches between the first operation cycle and the second operation cycle. Exemplarily, when the first switch control signal PWM1 is at a logic high level and the second switch control signal PWM2 is at a logic low level, it is the first operation cycle of the charge pump; and when the first switch control signal PWM1 is at a logic low level and the second switch control signal PWM2 is at a logic high level, it is the second operation cycle of the charge pump.

During the period from time t0 to time t1, the charge pump circuit is in the first operation cycle, the output voltage VOUT is greater than a preset output value VEE0 and gradually increases, the regulating signal G1 is a first preset control value G1_1, a voltage at the first terminal CAPP of the first capacitor C1 is the supply voltage VCC, a voltage at the second terminal CAPN of the first capacitor C1 is a reference ground voltage PGND, the pumping voltage VFLY is the supply voltage VCC, and the load current iload is a first load current iload1.

During the period from time t1 to time t2, the charge pump circuit is in the second operation cycle, the load current iload is the first load current iload1, the output voltage VOUT transitions to a value less than the preset output value VEE0 and then gradually increases, the regulating signal G1 is still the first preset control value G1_1, a voltage at the first terminal CAPP of the first capacitor C1 is a first preset charging value CAPP1, a voltage at the second terminal CAPN of the first capacitor C1 transitions to a value less than the reference ground voltage PGND and then gradually increases (but is always less than the reference ground voltage PGND), and the pumping voltage VFLY transitions to a first voltage V1 and then gradually decreases. It should be noted that the above-mentioned first voltage V1 refers to an initial value after the transition of the pumping voltage VFLY at the moment when the charge pump circuit switches to the second operation cycle each time; for different second cycles, the actual voltage values of the first voltage V1 may be different from each other.

During the period from time t2 to time t3, the charge pump circuit is in the second operation cycle, the load changes, the load current iload changes to a second load current iload2, the output voltage VOUT increases, but an increasing rate of the output voltage VOUT during this period is greater than an increasing rate of the output voltage VOUT during the period from t1 to t2, the regulating signal G1 increases, a voltage at the first terminal CAPP of the first capacitor C1 decreases, but an decreasing rate of the voltage at the first terminal CAPP of the first capacitor C1 during this period is greater than an decreasing rate of the voltage at the first terminal CAPP of the first capacitor C1 during the period from t1 to t2, a voltage at the second terminal CAPN of the first capacitor C1 increases, but an increasing rate of the voltage at the second terminal CAPN of the first capacitor C1 during this period is greater than an increasing rate of the voltage at the second terminal CAPN of the first capacitor C1 during the period from t1 to t2, the pumping voltage VFLY decreases, but a decreasing rate of the pumping voltage VFLY during this period is greater than a decreasing rate of the pumping voltage VFLY during the period from t1 to t2.

During the period from time t3 to time t4, the charge pump circuit is in the first operation cycle, the load current iload is the second load current iload2, the output voltage VOUT increases, the regulating signal G1 increases, a voltage at the first terminal CAPP of the first capacitor C1 is the supply voltage VCC, a voltage at the second terminal CAPN of the first capacitor C1 is the reference ground voltage PGND, and the pumping voltage VFLY between the first terminal CAPP and the second terminal of the first capacitor C1 is the supply voltage VCC.

During the period from time t4 to time t5, the charge pump circuit is in the second operation cycle, the load current iload is the second load current iload2, the output voltage VOUT transitions to a value less than the preset output value VEE0 and then gradually increases, the regulating signal G1 increases, a voltage at the first terminal CAPP of the first capacitor C1 decreases, a voltage at the second terminal CAPN of the first capacitor C1 transitions to a value less than the reference ground voltage PGND and then gradually increases (but is always less than the reference ground voltage PGND), and the pumping voltage VFLY between the first terminal CAPP and the second terminal of the first capacitor C1 transitions to the first voltage V1 and then gradually decreases, but the first voltage V1 during this period is less than the first voltage V1 during the period from t1 to t2, that is, the difference between the first voltage V1 and the supply voltage VCC during this period is greater than the difference between the first voltage V1 and the supply voltage VCC during the period from t1 to t2.

During the period from time t5 to time t6, the charge pump circuit is in the first operation cycle, the load current iload is the second load current iload2, the output voltage VOUT increases, the regulating signal G1 increases, a voltage at the first terminal CAPP of the first capacitor C1 is the supply voltage VCC, a voltage at the second terminal CAPN of the first capacitor C1 is the reference ground voltage PGND, and the pumping voltage VFLY between the first terminal CAPP and the second terminal of the first capacitor C1 is the supply voltage VCC.

During the period from time t6 to time t7, the charge pump circuit is in the second operation cycle, the load current iload is the second load current iload2, the output voltage VOUT transitions to a value less than the preset output value VEE0 and then gradually increases, the regulating signal G1 increases to a second preset control value G1_2, a voltage at the first terminal CAPP of the first capacitor C1 decreases, a voltage at the second terminal CAPN of the first capacitor C1 transitions to a value less than the reference ground voltage PGND and then gradually increases (but is always less than the reference ground voltage PGND), and the pumping voltage VFLY between the first terminal CAPP and the second terminal of the first capacitor C1 transitions to the first voltage V1 and then gradually decreases, but the first voltage V1 during this period is less than the first voltage V1 during the period from t4 to t5, that is, the difference between the first voltage V1 and the supply voltage VCC during this period is greater than the difference between the first voltage V1 and the supply voltage VCC during the period from t4 to t5.

During the period from time t7 to time t8, the charge pump circuit is in the first operation cycle, the load current iload is the second load current iload2, the output voltage VOUT increases, the regulating signal G1 is the second preset control value G1_2, a voltage at the first terminal CAPP of the first capacitor C1 is the supply voltage VCC, a voltage at the second terminal CAPN of the first capacitor C1 is the reference ground voltage PGND, and the pumping voltage VFLY between the first terminal CAPP and the second terminal of the first capacitor C1 is the supply voltage VCC.

During the period from time t8 to time t9, the charge pump circuit is in the second operation cycle, the load current iload is the second load current iload2, the output voltage VOUT transitions to a value less than the preset output value VEE0 and then gradually increases, the regulating signal G1 increases to the second preset control value G1_2, a voltage at the first terminal CAPP of the first capacitor C1 is a second preset charging value CAPP2, a voltage at the second terminal CAPN of the first capacitor C1 transitions to a value less than the reference ground voltage PGND and then gradually increases (but is always less than the reference ground voltage PGND), and the pumping voltage VFLY between the first terminal CAPP and the second terminal of the first capacitor C1 transitions to the first voltage V1 and then gradually decreases, but the first voltage V1 during this period is less than the first voltage V1 during the period from t6 to t7, that is, the difference between the first voltage V1 and the supply voltage VCC during this period is greater than the difference between the first voltage V1 and the supply voltage VCC during the period from t6 to t7.

In the embodiment shown in FIG. 6, by increasing the regulating signal G1, the difference between the first voltage V1 and the supply voltage VCC gradually increases from the period from t1 to t2, the period from t4 to t5, the period from t6 to t7 to the period from t8 to t9; therefore, the amount of charge that the first capacitor C1 charges the second capacitor C2 gradually decreases, and the output voltage VOUT that deviates from the preset output value VEE0 due to a sudden load change is gradually stabilized near the preset output value VEE0, thereby realizing stable control of the output voltage VOUT.

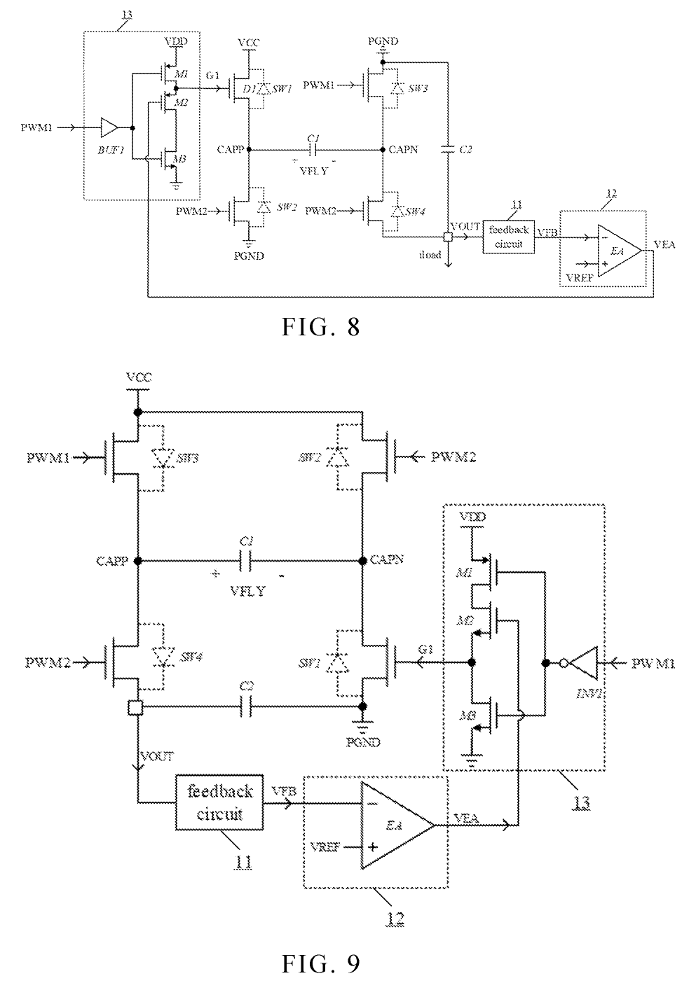

FIG. 8 is a schematic diagram of a circuit structure of a charge pump circuit according to an embodiment of the present application. A first terminal of the first capacitor C1 is coupled to the second terminal of the first switching transistor SW1, and the charge pump circuit further includes a second switching transistor SW2, a third switching transistor SW3, and a fourth switching transistor SW4, where the second switching transistor SW2 has a first terminal and a second terminal, the first terminal of the second switching transistor SW2 is coupled to the first terminal of the first capacitor C1, and the second terminal of the second switching transistor SW2 is coupled to the reference ground. The third switching transistor SW3 has a first terminal and a second terminal, the first terminal of the third switching transistor SW3 is coupled to the reference ground, and the second terminal of the third switching transistor SW3 is coupled to the second terminal of the first capacitor C1. The fourth switching transistor SW4 has a first terminal and a second terminal, the first terminal of the fourth switching transistor SW4 is coupled to the second terminal of the first capacitor C1, and the second terminal of the fourth switching transistor SW4 is coupled to the output port to provide the output voltage VOUT. During the first operation cycle, the first switching transistor SW1 and the third switching transistor SW3 are turned on, and the second switching transistor SW2 and the fourth switching transistor SW4 are turned off; and during the second operation cycle, the first switching transistor SW1 and the third switching transistor SW3 are turned off, and the second switching transistor SW2 and the fourth switching transistor SW4 are turned on.

In the embodiment shown in FIG. 8, the first switching transistor SW1 and the third switching transistor SW3 are turned on or turned off under the control of the first switch control signal PWM1, and the second switching transistor SW2 and the fourth switching transistor SW4 are turned on or turned off under the control of a second switch control signal PWM2, where the first switch control signal PWM1 is a pulse width modulation signal, the second switch control signal PWM2 is a pulse width modulation signal; in some embodiments, the first switch control signal PWM1 is a complementary signal for the second switch control signal PWM2, when the first switch control signal PWM1 is at a logic high level, the second switch control signal PWM2 is at a logic low level, and when the first switch control signal PWM1 is at a logic low level, the second switch control signal PWM2 is at a logic high level. In the embodiment shown in FIG. 8, a second capacitor C2 is further included, a first terminal of the second capacitor C2 is coupled to the reference ground, and a second terminal of the second capacitor C2 is coupled to the output port. During the first operation cycle, the first switching transistor SW1 and the third switching transistor SW3 are turned on, the second switching transistor SW2 and the fourth switching transistor SW4 are turned off, and the supply voltage VCC charges the first capacitor C1; and during the second operation cycle, the second switching transistor SW2 and the fourth switching transistor SW4 are turned on, the first switching transistor SW1 and the third switching transistor SW3 are turned off, the first capacitor C1 charges the second capacitor C2, and a positive voltage is converted into a negative voltage at the output port for output.

FIG. 9 is a schematic diagram of a circuit structure of a charge pump circuit according to an embodiment of the present application. A first terminal of the first capacitor C1 is coupled to the first terminal of the first switching transistor SW1, and the charge pump circuit further includes a second switching transistor SW2, a third switching transistor SW3, and a fourth switching transistor SW4, where the second switching transistor SW2 has a first terminal and a second terminal, the first terminal of the second switching transistor SW2 is coupled to the supply voltage VCC, and the second terminal of the second switching transistor SW2 is coupled to the first terminal of the first capacitor C1. The third switching transistor SW3 has a first terminal and a second terminal, the first terminal of the third switching transistor SW3 is coupled to the supply voltage VCC, and the second terminal of the third switching transistor SW3 is coupled to the second terminal of the first capacitor C1. The fourth switching transistor SW4 has a first terminal and a second terminal, the first terminal of the fourth switching transistor SW4 is coupled to the second terminal of the first capacitor C1, and the second terminal of the fourth switching transistor SW4 is coupled to the output port to provide the output voltage VOUT. During the first operation cycle, the first switching transistor SW1 and the third switching transistor SW3 are turned on, and the second switching transistor SW2 and the fourth switching transistor SW4 are turned off; and during the second operation cycle, the first switching transistor SW1 and the third switching transistor SW3 are turned off, and the second switching transistor SW2 and the fourth switching transistor SW4 are turned on.

In the embodiment shown in FIG. 9, the first switching transistor SW1 and the third switching transistor SW3 are turned on or turned off under the control of the first switch control signal PWM1, and the second switching transistor SW2 and the fourth switching transistor SW4 are turned on or turned off under the control of a second switch control signal PWM2, where the first switch control signal PWM1 is a pulse width modulation signal, the second switch control signal PWM2 is a pulse width modulation signal; in some embodiments, the first switch control signal PWM1 is a complementary signal for the second switch control signal PWM2, when the first switch control signal PWM1 is at a logic high level, the second switch control signal PWM2 is at a logic low level, and when the first switch control signal PWM1 is at a logic low level, the second switch control signal PWM2 is at a logic high level. In the embodiment shown in FIG. 9, a second capacitor C2 is further included, a first terminal of the second capacitor C2 is coupled to the reference ground, and a second terminal of the second capacitor C2 is coupled to the output port. During the first operation cycle, the first switching transistor SW1 and the third switching transistor SW3 are turned on, the second switching transistor SW2 and the fourth switching transistor SW4 are turned off, and the supply voltage VCC charges the first capacitor C1; and during the second operation cycle, the second switching transistor SW2 and the fourth switching transistor SW4 are turned on, the first switching transistor SW1 and the third switching transistor SW3 are turned off, and the first capacitor C1 charges the second capacitor C2, the supply voltage VCC is converted into a doubled voltage at the output port for output.

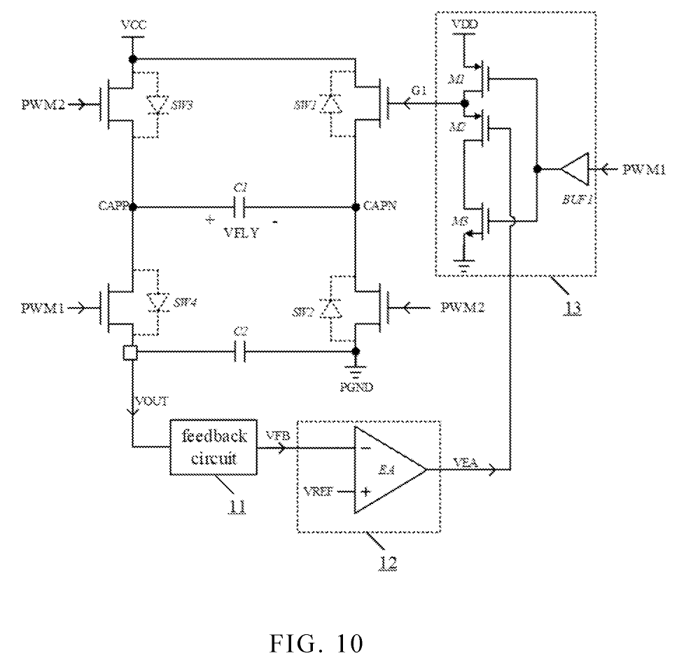

FIG. 10 is a schematic diagram of a circuit structure of a charge pump circuit according to an embodiment of the present application. A first terminal of the first capacitor C1 is coupled to the second terminal of the first switching transistor SW1, and the charge pump circuit further includes a second switching transistor SW2, a third switching transistor SW3, and a fourth switching transistor SW4, where the second switching transistor SW2 has a first terminal and a second terminal, the first terminal of the second switching transistor SW2 is coupled to the first terminal of the first capacitor C1, and the second terminal of the second switching transistor SW2 is coupled to the reference ground. The third switching transistor SW3 has a first terminal and a second terminal, the first terminal of the third switching transistor SW3 is coupled to the supply voltage VCC, and the second terminal of the third switching transistor SW3 is coupled to the second terminal of the first capacitor C1. The fourth switching transistor SW4 has a first terminal and a second terminal, the first terminal of the fourth switching transistor SW4 is coupled to the second terminal of the first capacitor C1, and the second terminal of the fourth switching transistor SW4 is coupled to the output port to provide the output voltage VOUT. During the first operation cycle, the second switching transistor SW2 and the third switching transistor SW3 are turned on, and the first switching transistor SW1 and the fourth switching transistor SW4 are turned off; and during the second operation cycle, the second switching transistor SW2 and the third switching transistor SW3 are turned off, and the first switching transistor SW1 and the fourth switching transistor SW4 are turned on.

In the embodiment shown in FIG. 10, the first switching transistor SW1 and the fourth switching transistor SW4 are turned on or turned off under the control of the first switch control signal PWM1, and the second switching transistor SW2 and the third switching transistor SW3 are turned on or turned off under the control of a second switch control signal PWM2, where the first switch control signal PWM1 is a pulse width modulation signal, the second switch control signal PWM2 is a pulse width modulation signal; in some embodiments, the first switch control signal PWM1 is a complementary signal for the second switch control signal PWM2, when the first switch control signal PWM1 is at a logic high level, the second switch control signal PWM2 is at a logic low level, and when the first switch control signal PWM1 is at a logic low level, the second switch control signal PWM2 is at a logic high level. In the embodiment shown in FIG. 10, a second capacitor C2 is further included, a first terminal of the second capacitor C2 is coupled to the reference ground, and a second terminal of the second capacitor C2 is coupled to the output port. During the first operation cycle, the second switching transistor SW2 and the third switching transistor SW3 are turned on, the first switching transistor SW1 and the fourth switching transistor SW4 are turned off, and the supply voltage VCC charges the first capacitor C1; and during the second operation cycle, the second switching transistor SW2 and the third switching transistor SW3 are turned off, the first switching transistor SW1 and the fourth switching transistor SW4 are turned on, and the supply voltage VCC is converted into a doubled voltage at the output port for output.

The present application further provides a control method for a charge pump circuit, applicable to the above-mentioned charge pump circuit. The charge pump circuit includes a first switching transistor SW1 and a first capacitor C1, the first switching transistor SW1 has a first terminal and a second terminal, and the first capacitor C1 has a first terminal and a second terminal, where the first capacitor C1 is connected to the first terminal or the second terminal of the first switching transistor SW1. The charge pump circuit converts an input voltage received by the input port into an output voltage VOUT by controlling on and off of the first switching transistor SW1. The control method includes generating a feedback voltage indicative of the output voltage VOUT according to the output voltage VOUT; and generating a regulating signal G1 according to the feedback voltage and a reference voltage to control an on-resistance of the first switching transistor SW1.

The above descriptions are merely preferred implementations of the present application. It should be pointed out that for those of ordinary skill in the technical field, several improvements and substitutions can be made without departing from the technical principles of the present application, and these improvements and substitutions should also be regarded as the protection scope of the present application.

What is claimed is:

1. A charge pump circuit, comprising:
an input port, configured to receive a supply voltage;
an output port, configured to provide an output voltage;
a first switching transistor, having a first terminal, a second terminal, and a control terminal, wherein when the first switching transistor is turned on, a current of the first switching transistor flows from the first terminal of the first switching transistor to the second terminal of the first switching transistor;
a first capacitor, having a first terminal and a second terminal, wherein the first terminal of the first capacitor is coupled to the first terminal of the first switching transistor or the second terminal of the first switching transistor; and
a regulating circuit, configured to receive the output voltage and a first switch control signal, and generate a regulating signal to control on and off of the first switching transistor according to the output voltage and the first switch control signal;
wherein the regulating signal is configured to control an on-resistance of the first switching transistor to regulate the output voltage.

2. The charge pump circuit according to claim 1, wherein the first switching transistor comprises a parasitic diode, wherein the first terminal of the first switching transistor is a cathode of the parasitic diode, and the second terminal of the first switching transistor is an anode of the parasitic diode.

3. The charge pump circuit according to claim 1, further comprising a second switching transistor, wherein during a first operation cycle, the first switching transistor is turned on, and the second switching transistor is turned off, and during a second operation cycle, the first switching transistor is turned off, and the second switching transistor is turned on.

4. The charge pump circuit according to claim 1, wherein the first switching transistor comprises an N-type field effect transistor.

5. The charge pump circuit according to claim 1, wherein the first switching transistor comprises a P-type field effect transistor.

6. The charge pump circuit according to claim 1, wherein the regulating circuit comprises:
a feedback circuit, configured to generate a feedback signal indicative of the output voltage according to the output voltage;
a calculation circuit, configured to generate a calculation signal according to the feedback signal and a reference voltage signal; and
a driving circuit, having a first input port configured to receive the first switch control signal, and a second input port configured to receive the calculation signal, wherein the driving circuit is configured to generate the regulating signal according to the first switch control signal and the calculation signal.

7. The charge pump circuit according to claim 6, wherein the first switch control signal is a square wave signal with a duty cycle of 50%.

8. The charge pump circuit according to claim 6, wherein the driving circuit comprises a first transistor, a second transistor, and a third transistor serially coupled between a power supply voltage and a reference ground.

9. The charge pump circuit according to claim 8, wherein the first transistor comprises a first terminal, a second terminal, and a control terminal, wherein the first terminal of the first transistor is configured to receive the power supply voltage, and the control terminal of the first transistor is configured to receive the regulating signal.

10. The charge pump circuit according to claim 8, wherein
the first transistor comprises a first terminal, a second terminal, and a control terminal, wherein the first terminal of the first transistor is configured to receive the power supply voltage, and the control terminal of the first transistor is configured to receive the first switch control signal;
the second transistor comprises a first terminal, a second terminal, and a control terminal, wherein the first terminal of the second transistor is coupled to the second terminal of the first transistor, and the control terminal of the second transistor is configured to receive the calculation signal; and
the third transistor comprises a first terminal, a second terminal, and a control terminal, wherein the first terminal of the third transistor is coupled to the second terminal of the second transistor and is configured to output the regulating signal, the second terminal of the third transistor is coupled to the reference ground, and the control terminal of the third transistor is configured to receive the first switch control signal.

11. The charge pump circuit according to claim 8, wherein
the first transistor comprises a first terminal, a second terminal, and a control terminal, wherein the first terminal of the first transistor is configured to receive the power supply voltage, and the control terminal of the first transistor is configured to receive the first switch control signal;
the second transistor comprises a first terminal, a second terminal, and a control terminal, wherein the first terminal of the second transistor is coupled to the second terminal of the first transistor and is configured to output the regulating signal, and the control terminal of the second transistor is configured to receive the calculation signal; and
the third transistor comprises a first terminal, a second terminal, and a control terminal, wherein the first terminal of the third transistor is coupled to the second terminal of the second transistor, the second terminal of the third transistor is coupled to the reference ground, and the control terminal of the third transistor is configured to receive the first switch control signal.

12. The charge pump circuit according to claim 1, wherein the first terminal of the first capacitor is coupled to the first terminal of the first switching transistor, wherein the charge pump circuit further comprises:
a second switching transistor, having a first terminal and a second terminal, wherein the first terminal of the second switching transistor is coupled to the input port to receive the supply voltage, and the second terminal of the second switching transistor is coupled to the first terminal of the first switching transistor;
a third switching transistor, having a first terminal and a second terminal, wherein the first terminal of the third switching transistor is coupled to a reference ground, and the second terminal of the third switching transistor is coupled to the second terminal of the first capacitor; and
a fourth switching transistor, having a first terminal and a second terminal, wherein the first terminal of the fourth switching transistor is coupled to the second terminal of the first capacitor, and the second terminal of the fourth switching transistor is coupled to the output port to provide the output voltage;
wherein, during a first operation cycle, the first switching transistor and the fourth switching transistor are turned off, and the second switching transistor and the third switching transistor are turned on, and during a second operation cycle, the first switching transistor and the fourth switching transistor are turned on, and the second switching transistor and the third switching transistor are turned off.

13. The charge pump circuit according to claim 12, further comprising a second capacitor having a first terminal and a second terminal, wherein the first terminal of the second capacitor is coupled to the reference ground, and the second terminal of the second capacitor is coupled to the output port.

14. The charge pump circuit according to claim 1, wherein the first terminal of the first capacitor is coupled to the second terminal of the first switching transistor, wherein the charge pump circuit further comprises:
a second switching transistor, having a first terminal and a second terminal, wherein the first terminal of the second switching transistor is coupled to the first terminal of the first capacitor, and the second terminal of the second switching transistor is coupled to the reference ground;
a third switching transistor, having a first terminal and a second terminal, wherein the first terminal of the third switch is coupled to the reference ground, and the second terminal of the third switching transistor is coupled to the second terminal of the first capacitor; and
a fourth switching transistor, having a first terminal and a second terminal, wherein the first terminal of the fourth switching transistor is coupled to the second terminal of the first capacitor, and the second terminal of the fourth switching transistor is coupled to the output port to provide the output voltage;
wherein, during a first operation cycle, the first switching transistor and the third switching transistor are turned on, and the second switching transistor and the fourth switching transistor are turned off, and during a second operation cycle, the first switching transistor and the third switching transistor are turned off, the second switching transistor and the fourth switching transistor are turned on.

15. The charge pump circuit according to claim 14, further comprising a second capacitor having a first terminal and a second terminal, wherein the first terminal of the second capacitor is coupled to the reference ground, and the second terminal of the second capacitor is coupled to the output port.

16. The charge pump circuit according to claim 1, wherein the first terminal of the first capacitor is coupled to the first terminal of the first switching transistor, wherein the charge pump circuit further comprises:
a second switching transistor, having a first terminal and a second terminal, wherein the first terminal of the second switching transistor is coupled to the supply voltage, and the second terminal of the second switching transistor is coupled to the first terminal of the first capacitor;
a third switching transistor, having a first terminal and a second terminal, wherein the first terminal of the third switching transistor is coupled to the supply voltage, and the second terminal of the third switching transistor is coupled to the second terminal of the first capacitor;
a fourth switching transistor, having a first terminal and a second terminal, wherein the first terminal of the fourth switching transistor is coupled to the second terminal of the first capacitor, and the second terminal of the fourth switching transistor is coupled to the output port to provide the output voltage; and
wherein, during a first operation cycle, the first switching transistor and the third switching transistor are turned on, and the second switching transistor and the fourth switching transistor are turned off, and during a second operation cycle, the first switching transistor and the third switching transistor are turned off, and the second switching transistor and the fourth switching transistor are turned on.

17. The charge pump circuit according to claim 16, further comprising a second capacitor having a first terminal and a second terminal, wherein the first terminal of the second capacitor is coupled to a reference ground, and the second terminal of the second capacitor is coupled to the output port.

18. The charge pump circuit according to claim 1, wherein the first terminal of the first capacitor is coupled to the second terminal of the first switching transistor, wherein the charge pump circuit further comprises:
a second switching transistor, having a first terminal and a second terminal, wherein the first terminal of the second switching transistor is coupled to the first terminal of the first capacitor, and the second terminal of the second switching transistor is coupled to the reference ground;
a third switching transistor, having a first terminal and a second terminal, wherein the first terminal of the third switching transistor is coupled to the supply voltage, and the second terminal of the third switching transistor is coupled to the second terminal of the first capacitor; and
a fourth switching transistor, having a first terminal and a second terminal, wherein the first terminal of the fourth switching transistor is coupled to the second terminal of the first capacitor, and the second terminal of the fourth switching transistor is coupled to the output port to provide the output voltage;
wherein, during a first operation cycle, the second switching transistor and the third switching transistor are turned on, and the first switching transistor and the fourth switching transistor are turned off, and during a second operation cycle, the second switching transistor and the third switching transistor are turned off, and the first switching transistor and the fourth switching transistor are turned on.

19. The charge pump circuit according to claim 18, further comprising a second capacitor having a first terminal and a second terminal, wherein the first terminal of the second capacitor is coupled to the reference ground, and the second terminal of the second capacitor is coupled to the output port.

20. A control method for a charge pump circuit, wherein the charge pump circuit comprises a first switching transistor and a first capacitor, wherein the first switching transistor comprises a first terminal and a second terminal, and the first capacitor comprises a first terminal and a second terminal, wherein the first capacitor is connected to the first terminal or the second terminal of the first switching transistor, and the charge pump circuit is configured to convert an input voltage received by an input port into an output voltage by controlling on and off of the first switching transistor, wherein the control method comprises:
generating a feedback voltage indicative of the output voltage according to the output voltage; and
generating a regulating signal according to the feedback voltage and a reference voltage to control an on-resistance of the first switching transistor.
